(19) United States
(12) Patent Application Publication
(10) Pub. No.: US 2014/0299740 A1
(43) Pub. Date: Oct. 9, 2014

(54) Electronic Device Support

(71) Applicant: Acer Incorporated, New Taipei City (TW)

(72) Inventors: Hsueh-Chih Peng, New Taipei City (TW); Tsun-Chih Yang, New Taipei City (TW)

(73) Assignee: Acer Incorporated, New Taipei City (TW)

(21) Appl. No.: 14/230,135

(22) Filed: Mar. 31, 2014

(30) Foreign Application Priority Data
Apr. 9, 2013 (TW) 102112515

(51) Int. Cl. F16M 13/00

(52) U.S. Cl. CPC F16M 13/005
USPC 248/688; 248/682

(57) ABSTRACT

An electronic device support includes a main body. A groove extends on the main body and allows an electronic device to insert. A support frame is pivotally mounted to the main body. The support frame is capable of rising and holding the electronic device on an elevation angle. A positioning mechanism includes two first magnetic members embedded in the support frame. The first magnetic members are capable of magnetically restraining the electronic device.

### BACKGROUND OF THE INVENTION

1. Field of the Invention

The present invention relates to an electronic device support and, particularly to an electronic device support capable of quickly connecting to an electronic device and keeping it rest on a fixed elevation angle.

2. Description of the Related Art

Advances in technology and the ways we have used new technologies have changed our lives. For example, when smart phones and tablets appear and more people started using them, a post-PC era starts to begin. In fact, a tablet, which fits a demand for high mobility and allows people to work in different places, has been widely used to handle tasks now. Generally, a user can hold a tablet with one hand and operate it with the other hand or use it on the lap. With hotdesking, work areas, however, are no longer configured correctly, and many people already report suffering neck, back, or arm strains.

Therefore, TW Patent No. M419963 shows a tablet with an elevation-angle linkage mechanism. The invention includes an input device capable of lifting the tablet. Furthermore, the elevation-angle linkage mechanism includes a first pivot mechanism pivotally engaging with the backside of the tablet and a second pivot mechanism pivotally engaging with the input device. The tablet can be elevated on an angle. Therefore, the tablet can work more like a laptop and become a more ergonomic workstation. However, such design can't allow a user to separate the tablet from the elevation-angle linkage mechanism easily. Furthermore, it is also not convenient and easy to disengage the first pivot mechanism from the tablet due to that the first pivot mechanism is attached to the backside of the tablet.

In addition, TW Patent No. M414799 discloses a box stand for a tablet. The box stand includes a pivotal support board capable of being elevate a tablet on an angle. However, the invention doesn't allow a tablet to connect to the box stand. Therefore, it may be inconvenient for a user to carry the tablet and the box stand at the same time.

The present invention is, therefore, intended to obviate or at least alleviate the problems encountered in the prior art.

### SUMMARY OF THE INVENTION

According to the present invention, an electronic device support includes a main body. A groove extends on the main body and allows an electronic device to insert. A support frame is pivotally mounted to the main body. The support frame is capable of rising and holding the electronic device on an elevation angle. A positioning mechanism includes two first magnetic members embedded in the support frame. The first magnetic members are capable of magnetically restraining the electronic device.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide an electronic device support capable of quickly connecting to an electronic device and keeping it rest on a fixed elevation angle.

Other objects, advantages, and new features of the present invention will become apparent from the following detailed description of the invention when considered in conjunction with the accompanied drawings.

### BRIEF DESCRIPTION OF THE DRAWINGS

FIG. 1 is a perspective view of an electronic device support in accordance with a first embodiment of the present invention.

FIG. 2 is an exploded perspective view of an electronic device support.

FIG. 3 is an exploded perspective view of an electronic device support, viewed from a different angle than FIG. 2.

FIG. 4 is a cross-sectional view of FIG. 1.

FIG. 5 is a partial, enlarged view of FIG. 4.

FIG. 6 is a perspective view of the electronic device support and an electronic device, with the electronic device elevated on an angle by the electronic device support.

FIG. 7 is a perspective view of the electronic device support and the electronic device, viewed from a different angle than FIG. 6.

FIG. 8 is a cross-sectional view of the electronic device support and the electronic device.

FIG. 9 is a perspective view of the electronic device support and the electronic device, with the electronic device support in a collapsed position and the electronic device stacked in a position substantially parallel to a main body of the electronic device support.

FIG. 10 is a cross-sectional view of FIG. 9.

FIG. 11 is an exploded perspective view of an electronic device support in accordance with a second embodiment of the present invention in use with the electronic device.

FIG. 12 is a schematic view illustrating the electronic device capable of connecting to the electronic device support.

FIG. 13 is a partial cross-sectional view of the electronic device support and the electronic device shown in FIG. 12.

### DETAILED DESCRIPTION OF THE INVENTION

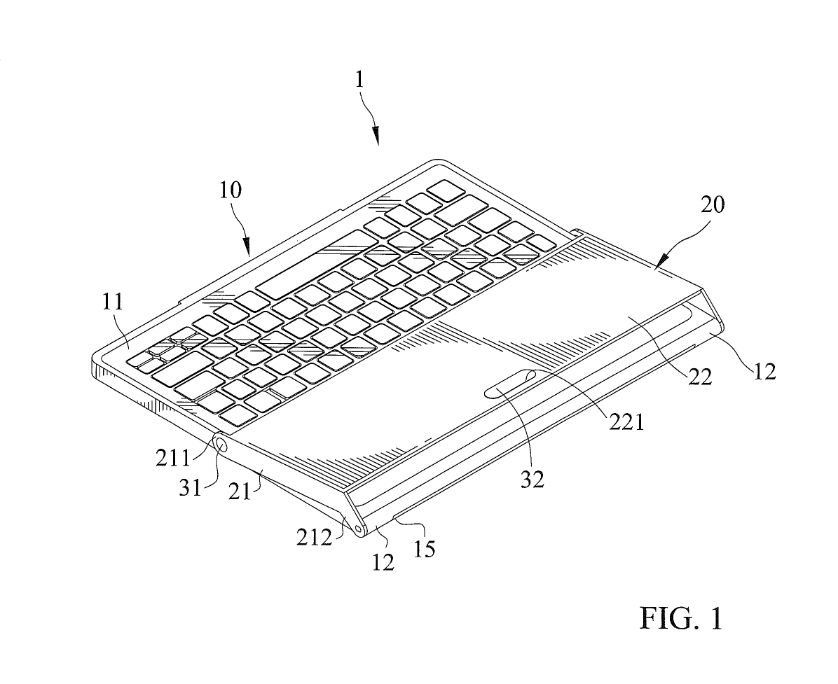

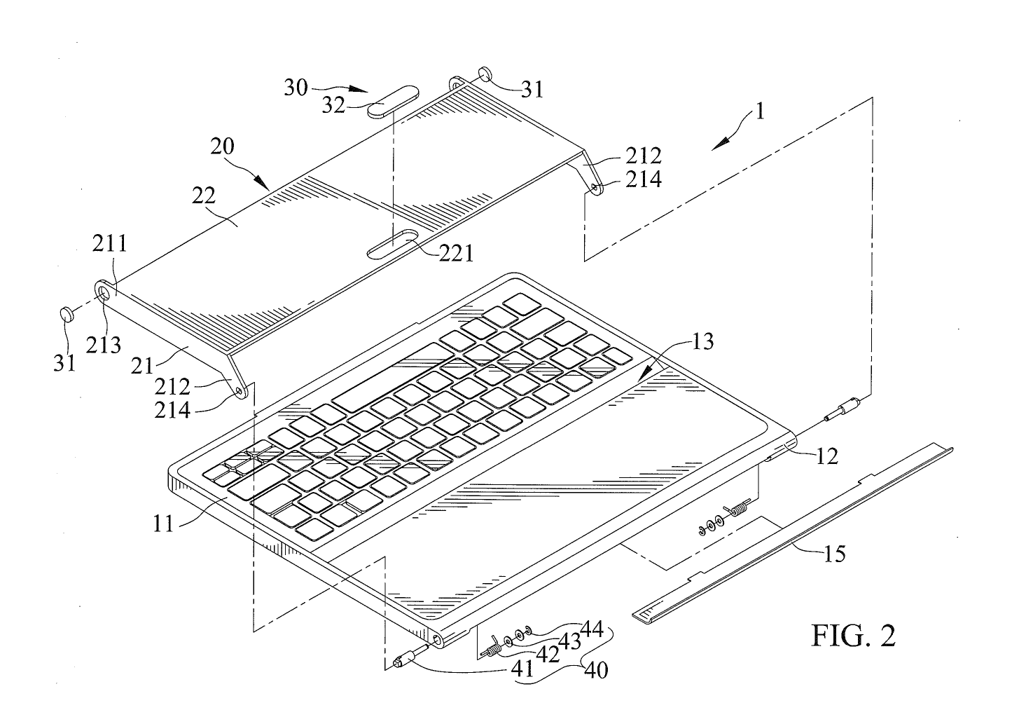

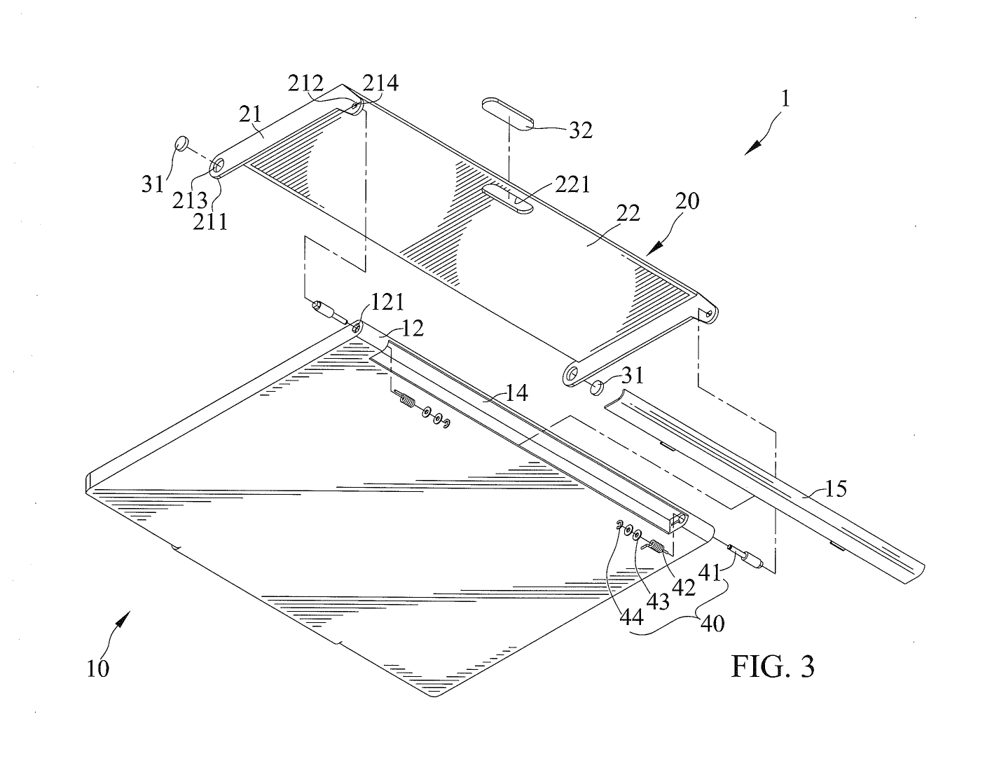

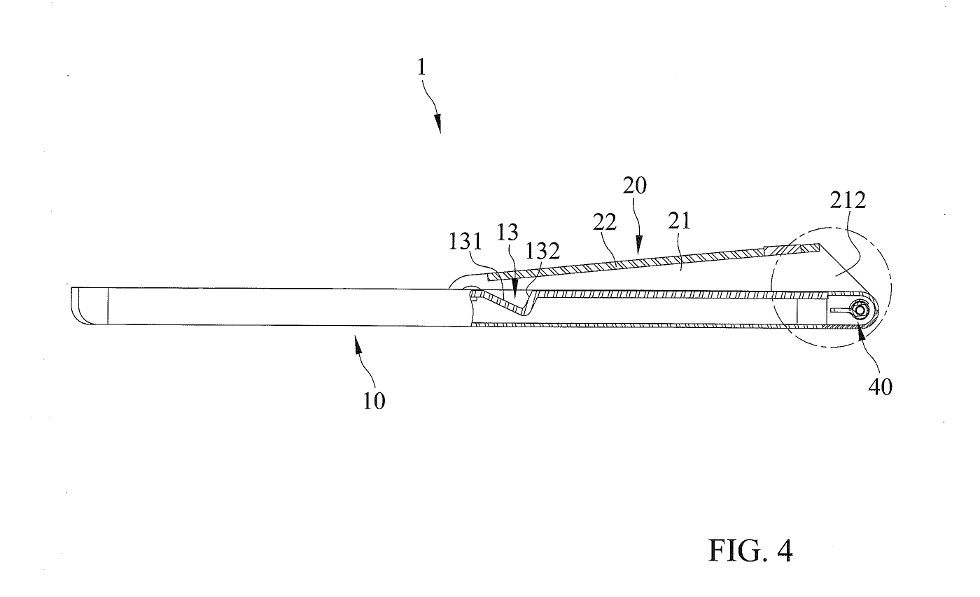

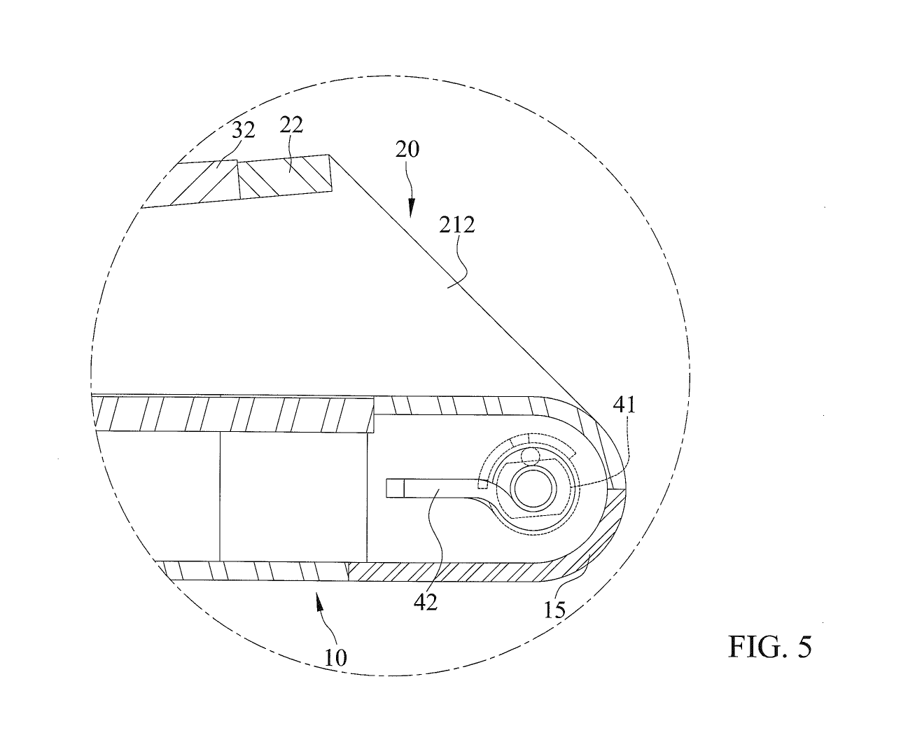

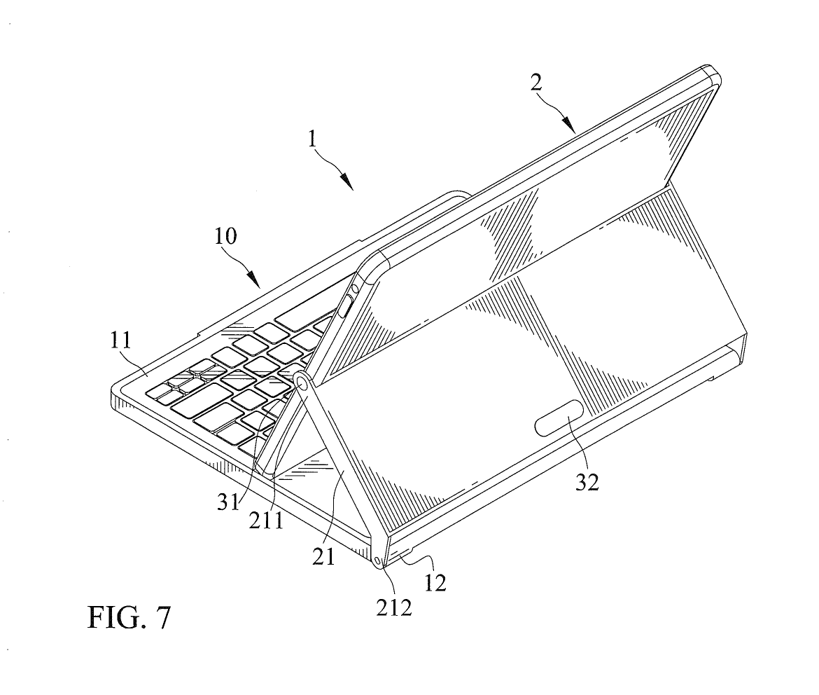

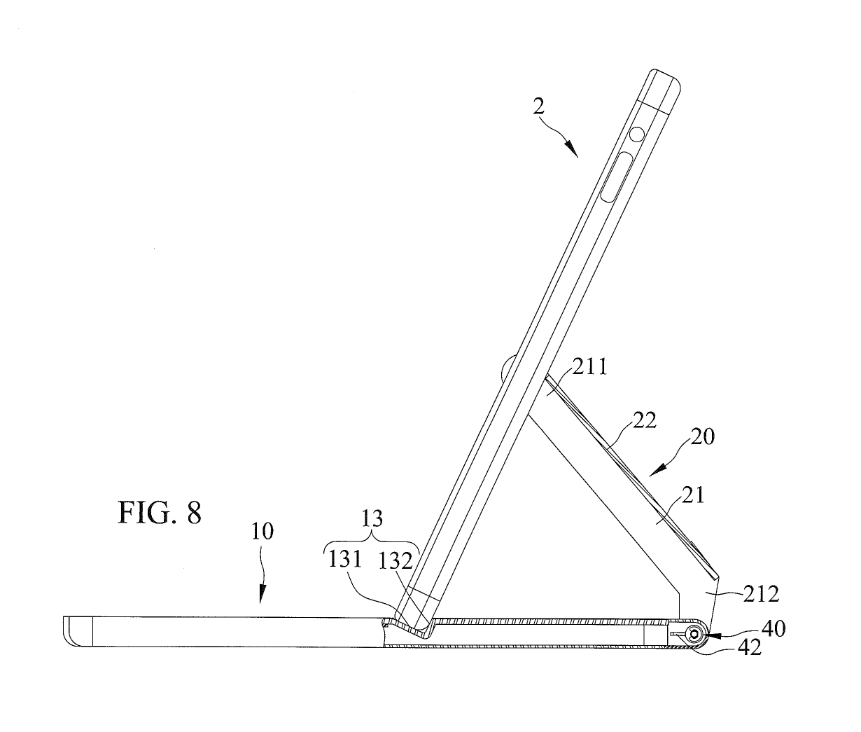

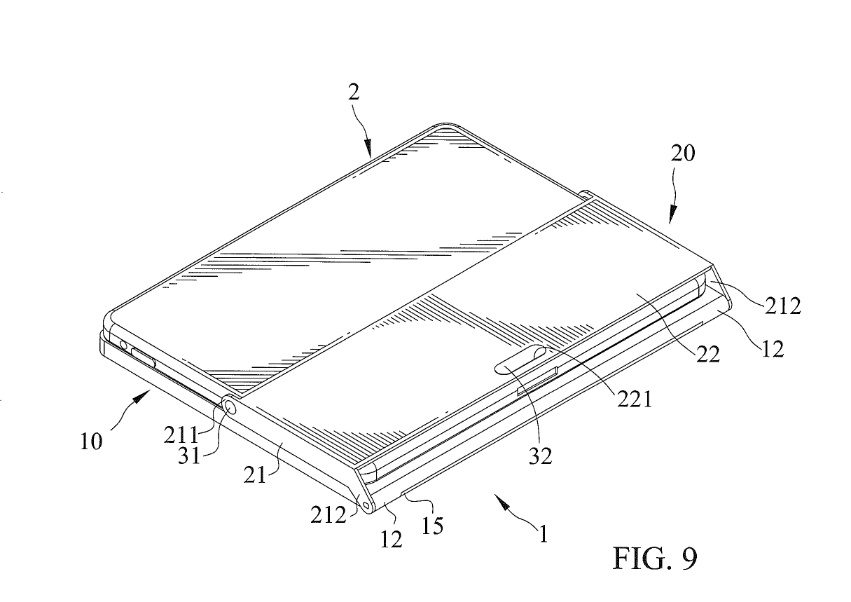

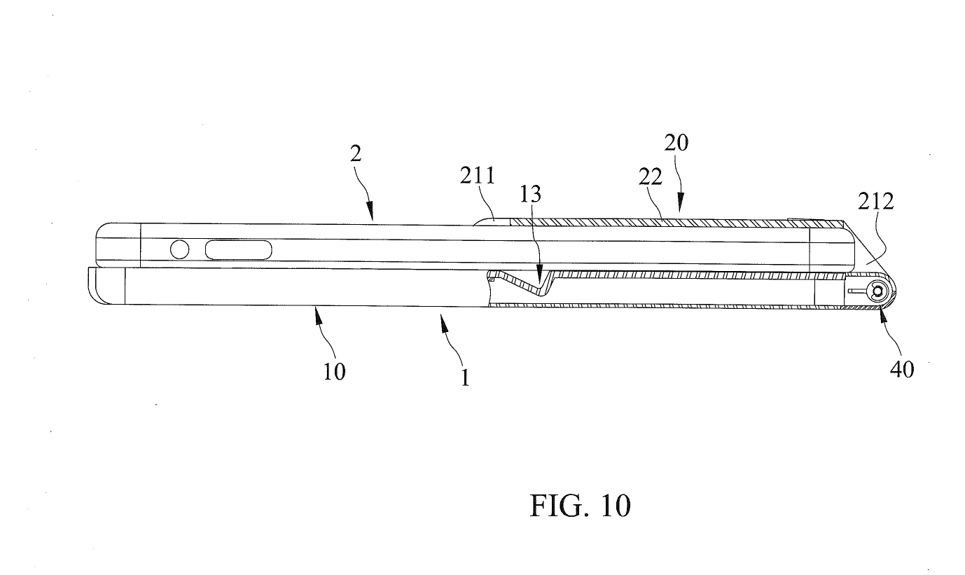

FIGS. 1 through 10 show an electronic device support 1 in accordance with a first embodiment of the present invention. The electronic device support 1 includes a main body 10, a support frame 20, and a positioning mechanism 30.

A groove 13 extends on the main body 10. An electronic device 2 can insert into the groove 13. The groove 13 is capable of bearing and making the electronic device 2 rest obliquely with respect to the main body 10. The groove 13 includes a first abutting edge 131 and a second abutting edge 132 extending obliquely from the first abutting edge 131. The first abutting edge 131 is capable of abutting against a circumferential edge of the electronic device 2 and the second abutting edge 132 is capable of abutting against a backside of the electronic device 2, respectively. The main body 10 includes an input interface 11 allowing the electronic device 2 to connect and permitting an input into the electronic device 2. The input interface 11 wirelessly connects to an electronic device 2 and inputs information and signal to the electronic device 2. The electronic device 2 has a plate configuration. The electronic device 2 can be a tablet, a touchscreen, or a smart phone etc. With the input interface 11, the electronic device 2 can work more like a laptop. The main body 10 has two lateral edges and defines two first pivot connections 12 on the two lateral edges. One of the two first pivot connections 12 is defined on one of the two lateral edges and the other of the two first pivot connections 12 defined on the other of the two lateral edges, respectively.

The support frame 20 is pivotally mounted to the main body 10. The support frame 20 is capable of rising and holding the electronic device 2 on an elevation angle. In addition, the support frame 20 is pivotal to a collapsed position where the support frame 20 is stacked onto the main body 10 and capable of restraining and making the electronic device 2 stacked substantially parallel to the main body 10 of the electronic device support 1. The support frame 20 has two arms 21 and a frame body 22 interconnecting the two arms 21. The support frame 20 has two arms 21 and a frame body 22 formed between the two arms 21. Each of the two arms 21 defines a connecting end 211 and a second pivot connection 212. Each of the two arms 21 includes the second pivot connection 212 pivotally joining to one of the two first pivot connections 12. The second pivot connection 212 of each of the two arms 21 pivotally fixes to one of the first pivot connections 12 of the main body 10. The frame body 22 defines a receiving area 221 in the form of a hole.

The positioning mechanism 30 includes two first magnetic members 31 embedded in the support frame 20. The positioning mechanism 30 includes two first magnetic members 31 embedded at a different end of the support frame 20 than the support frame 20. The first magnetic members 31 are capable of magnetically restraining the electronic device 2. Each of the two arms 21 includes the connecting end 211 receiving one of the two first magnetic members 31. The connecting end 211 of each of the two arms 21 includes a cavity 213 receiving one of the two first magnetic members 31. Moreover, the positioning mechanism 30 includes a second magnetic member 32 embedded in the frame body 22 of the support frame 20 capable of magnetically restraining the electronic device 2 stacked on the main body 10. The second magnetic member 32 is embedded in the receiving area 221.

Further, two hinge mechanisms 40 each include an end engaging with one of the two first pivot connections 12 and another end engaging with one of the two second pivot connections 212, respectively. Each of the two hinge mechanisms 40 includes a hinge 41, a biasing member 42, a plurality of spacers 43, and a retaining member 44 engaging with the hinge 41 and restraining the biasing member 42 and the plurality of spacers 43 on the hinge 41. The biasing member 42 is a torsion spring. The retaining member 44 is a C-ring. Each of the two first pivot connections 12 defines a first engaging area 121 in the form of a hole receiving one of the two hinge mechanisms 40. Each of the two second pivot connections 212 defines a second engaging area 214 in the form of a hole receiving one of the two hinge mechanisms 40. In addition, the main body 10 includes a compartment 14 extending between the two first engaging areas 121, with one end of the compartment 14 connecting to one of the two first engaging areas 121 and another end of the compartment connecting to the other of the two first engaging areas 121, respectively. Furthermore, the compartment 14 delimits an opening on the outer periphery of the main body 10. Thus, a user is able to insert the two hinge mechanisms 40 into the compartment 14. Further, a cover 15 is releasably engaged with the main body to cover the opening of the compartment. The cover 15 can prevent the compartment from dirt.

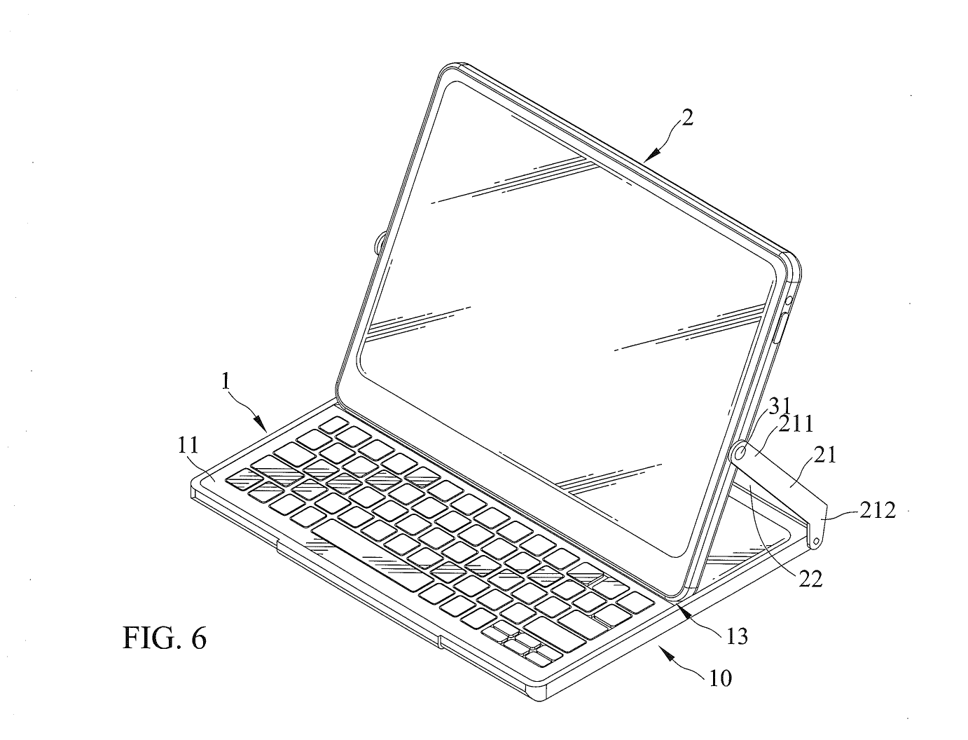

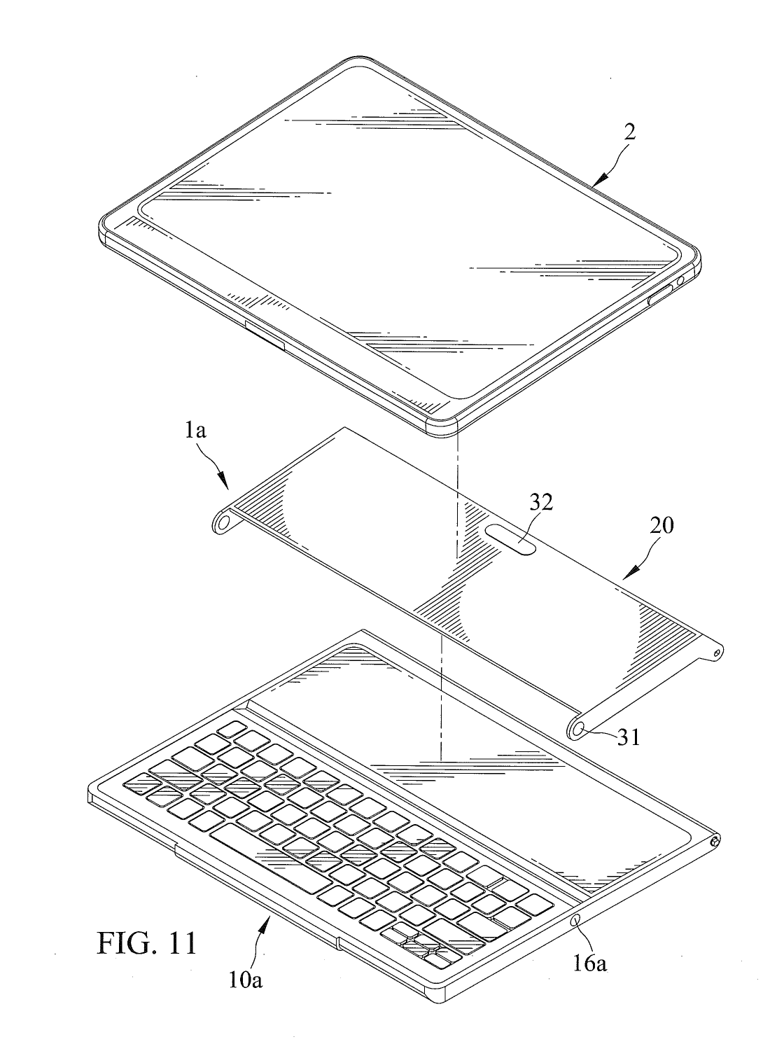

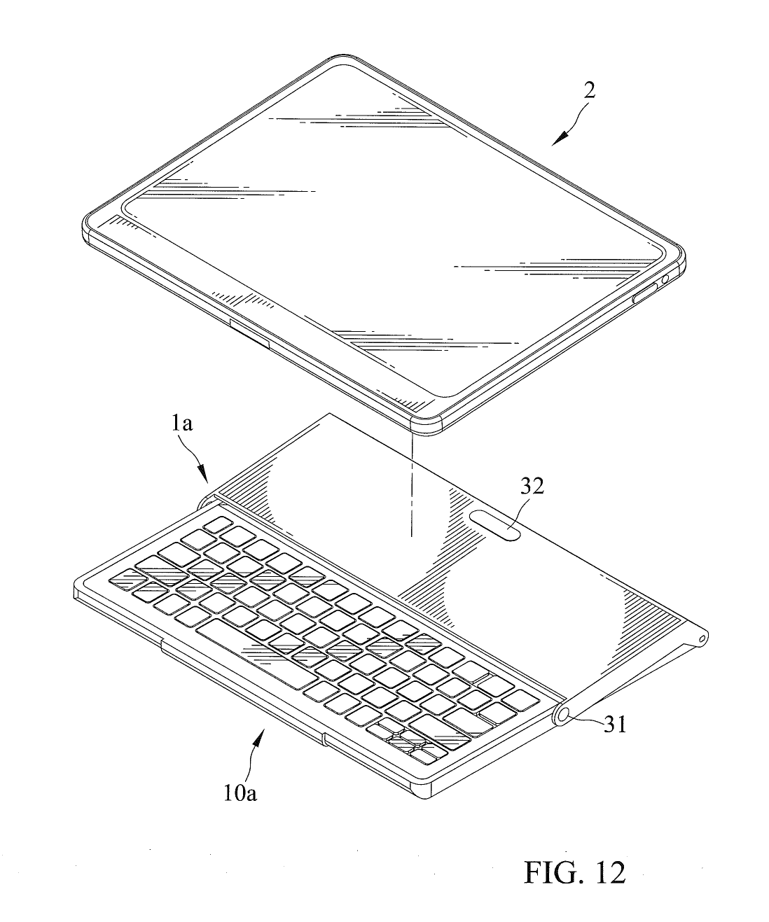

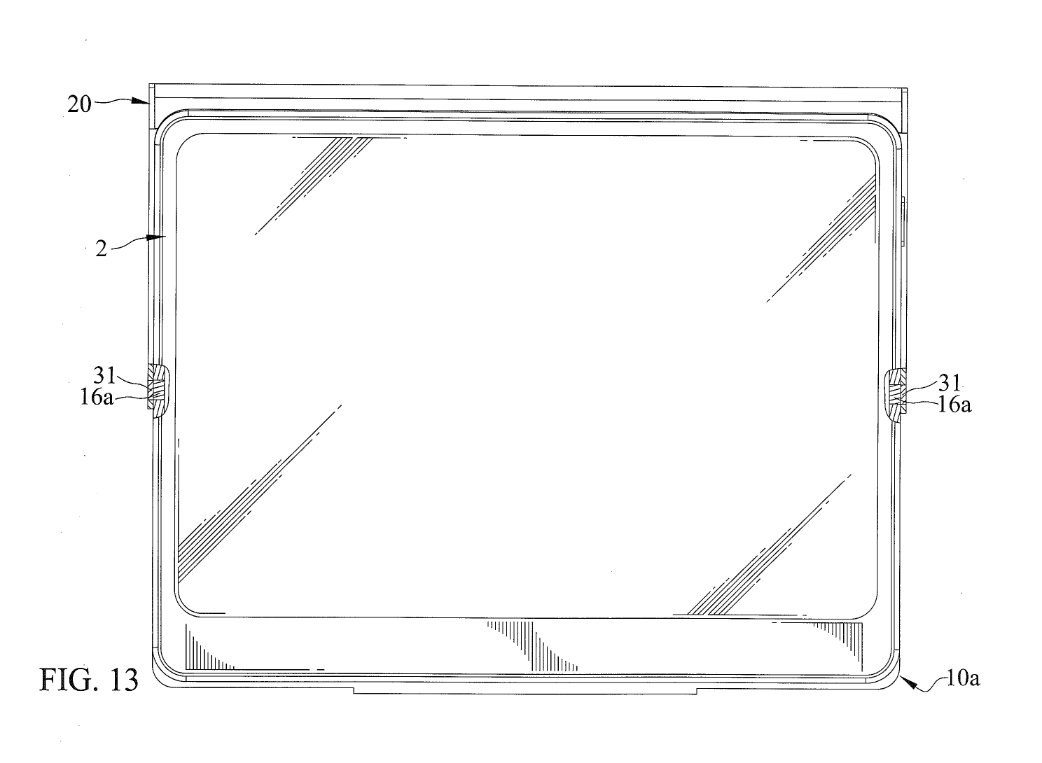

Referring to FIGS. 6 through 10, a user can operatively force the support frame 20 to move, with the two hinge mechanisms 40 allowing the support frame 20 to pivot relative to the main body 10. The electronic device 2 can be quickly positioned and connected to the electronic device support 1 and elevated with respect to the input interface 11 of the main body 10 at an angle greater than 90 degrees, with the bottom abutting against the first abutting edge 131, with the backside abutting against the second abutting edge 132 and the frame body 22, and with two lateral edges abutting against the two first connecting ends 211 of the two arms 21 of the support frame 20 and magnetically engaging with the two first magnetic members 31. In addition, when the electronic device 2 is detached from the electronic device support 1, the biasing member 42 of each hinge mechanism 40 can release from tension to make the support frame 20 automatically pivot relative to the main body 10. The electronic device 2 can be disposed in a flat position on the main body 10 and stacked between the main body 10 and the support frame 20, with the two lateral sides abutting against the two first connecting ends of the two arms of the support frame 20 and magnetically engaging with the two first magnetic members 31, with the backside abutting against the frame body 22 of the support frame 20 and magnetically engaging with the second magnetic member 32. p FIGS. 11 through 13 show an electronic device support 1a in accordance with a second embodiment of the present invention, and same numbers are used to correlate similar components of the first embodiment, but bearing a letter a. The second embodiment differentiates from the first embodiment in that it includes a main body 10a. The main body 10a differentiates from the main body 10 in that it further includes two magnets 16a. The third magnetic member 16a magnetically engages with two first magnetic members 31. The support frame 20 in the collapsed position thereof including the two first magnetic members 31 magnetically engaging with the two magnets 16a embedded in the main body 10a. Therefore, the support frame 20 is magnetically restrained to the main body 10a by the two first magnetic members 31 magnetically engaging with the two magnets 16a.

In view of the forgoing, the electronic device supports 1 and 1a can quickly connect to the electronic device 2 and keeping it rest on a fixed elevation angle. In addition, the support frame 20 is pivotal to the collapsed position thereof capable of restraining and making the electronic device 2 stacked substantially parallel to the main bodies 10 and 10a of the electronic device supports 1 and 1a.

While the specific embodiments have been illustrated and described, numerous modifications come to mind without significantly departing from the spirit of invention, and the scope of invention is only limited by the scope of accompanying claims.

What is claimed is:

1. An electronic device support comprising:
a main body, and a groove extending on the main body;
a support frame, including an end pivotally fixing to the main body; and
a positioning mechanism including two first magnetic members embedded at a different end of the support frame than the support frame.

2. The electronic device support as claimed in claim 1, wherein the main body has an end including two lateral edges forming two first pivot connections respectively, and wherein the support frame has two arms and a frame body formed between the two arms, with each of the two arms having two opposite ends defining a connecting end and a second pivot connection respectively, with the connecting end of each of the two arms including a cavity receiving one of the two first magnetic members of the positioning mechanism, and with second pivot connection of each of the two arms pivotally fixing to one of the first pivot connections of the main body.

3. The electronic device support as claimed in claim 2, wherein the groove includes a first abutting edge and a second abutting edge, and wherein an electronic device engaging with the electronic device support includes a bottom abutting against the first abutting edge and a backside abutting against the second abutting edge and the frame body of the support frame, and is elevated at a fixed angle with respect to the main body.

4. The electronic device support as claimed in claim 2, wherein the frame body of the support frame includes a receiving area in the form of a hole, and wherein the positioning mechanism includes a second magnetic member engaged in the receiving area of the frame body.

5. The electronic device support as claimed in claim 4, wherein an electronic device is able to be stacked between the main body and the support frame, with the electronic device having two lateral sides abutting against the connecting ends of the two arms and magnetically engaging with the two first magnetic members, with a backside of the electronic device abutting against the support frame and magnetically engaging with the second magnetic member, and with the electronic device engaging with the electronic device support in a flat stacking arrangement.

6. The electronic device support as claimed in claim 2 further comprising two hinge mechanisms, with the two first pivot connections of the main body each include a first engaging area in the form of a recess, with the second pivot connection of each of the two arms including a second engaging area in the form of a through hole, with each of the two hinge mechanisms including a hinge, a biasing member, a plurality of spacers and a retaining member, with the hinge having an end engaging in the second engaging area of one of the two arms and another end inserting through the biasing member and the plurality of spacers and including the retaining member fixing thereto, with anther end of the hinge, the biasing member, the plurality of spacers and the retaining member received in the first engaging area of one of the two first connections

7. The electronic device support as claimed in claim 6, wherein the biasing member is a torsion spring.

8. The electronic device support as claimed in claim 6, wherein the retaining member is a C-ring.

9. The electronic device support as claimed in claim 1, wherein the main body includes a third magnetic member magnetically engaging with two first magnetic members.

10. The electronic device support as claimed in claim 1, wherein main body includes an input interface wirelessly connecting to an electronic device and inputting information and signal to the electronic device.
